(19) United States
(12) Patent Application Publication
(10) Pub. No.: US 2018/0165747 A1
(43) Pub. Date: Jun. 14, 2018

(54) CUSTOMIZED ONLINE NUTRITION AND GROCERY SHOPPING MANAGEMENT SYSTEMS AND METHODS

(71) Applicant: Wal-Mart Stores, Inc., Bentonville, AR (US)

(72) Inventors: Robert Patten, Rogers, AR (US); Krishna Pavan Bhat, Seattle, WA (US)

(21) Appl. No.: 15/838,758

(22) Filed: Dec. 12, 2017

Related U.S. Application Data
(60) Provisional application No. 62/432,969, filed on Dec. 12, 2016.

(51) Int. Cl. G06Q 30/06; G06F 17/30

(52) U.S. Cl. CPC G06Q 30/0631; G06Q 30/0633; G06F 17/30943; G06Q 30/0603

(57) ABSTRACT

Embodiments relate to systems and methods for managing online grocery shopping. A system for nutrition and shopping management in an online networked environment generally includes a user interface, a nutrition management engine, a meal planning engine, a shopping list management engine, and a customer records database. Using customer records stored in customer records database, the nutrition management engine receives customer-specific nutritional requirements, the meal planning engine generally suggests recipes and meal plans, and the shopping list management engine provides a suggested shopping list based on the recipes and meal plans in view of the customer-specific nutritional requirements.

### RELATED APPLICATION

The present application claims the benefit of U.S. Provisional Application No. 62/432,969 filed Dec. 12, 2016, which is incorporated herein by reference in its entirety.

### TECHNICAL FIELD

Embodiments relate generally to online shopping and more particularly to systems and methods for online grocery shopping customization.

### BACKGROUND

Most retailers offer some form of online shopping experience for their customers. Traditional grocery retailers typically offer a very basic online shopping experience whereby a customer selects particular groceries via an Internet interface, and the groceries are either delivered to the customer or picked up at the store. Such systems are often generic to every customer, offering little advantage over physical in-store shopping.

Therefore, there is a need for systems and methods that customize online grocery shopping for particular nutrition plans, meal packs, and other customer-specific shopping recommendations.

### SUMMARY

In an embodiment, a nutrition and shopping management system comprises a nutrition management engine configured to receive and store customer-specific nutritional requirements in a customer record, each customer record associated with one of a plurality of customers; a meal planning engine configured to receive recipes and meal plans from at least one customer and at least one publicly available source and to suggest recipes and meal plans to customers based on the customer-specific nutritional requirements, wherein the meal planning engine is configured to store recipes and meal plans received from a customer, or selected by a customer in response to a suggestion, in the customer record of that customer, and wherein the meal planning engine is configured to identify customer records having common customer-specific nutritional requirements and to cross-suggest recipes and meal plans to the customers associated with the identified customer records; and a shopping list management engine configured to receive recipes and meal plans provided or selected by a customer and to provide a suggested shopping list comprising items required by the recipes and meals plans and available from the retailer, wherein the shopping list management engine is configured to store a history of purchased items by a customer in the customer record and to review the customer record to provide previous purchase information if an item in the suggested shopping list is identified in the history as a previously purchased item.

In an embodiment, a nutrition and shopping management method comprises receiving and storing customer-specific nutritional requirements in a customer record, each customer record associated with one of a plurality of customers; receiving recipes and meal plans from at least one customer and at least one publicly available source; suggesting received recipes and meal plans to a customer based on the customer-specific nutritional requirements in the customer record; storing recipes and meal plans received from a customer, or selected by a customer in response to a suggestion, in the customer record of that customer; identifying customer records having common customer-specific nutritional requirements and cross-suggesting recipes and meal plans to the customers associated with the identified customer records; and providing a suggested shopping list to a customer comprising items required by recipes and meals plans selected by the customer and available from the retailer; storing a history of purchased items by a customer in the customer record; and reviewing the customer record to provide previous purchase information if an item in the suggested shopping list is identified in the history as a previously purchased item.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a nutrition and shopping management system, according to an embodiment.

FIG. 2 is a block diagram of a customer record according to an embodiment.

FIG. 3 is a block diagram of another nutrition and shopping management system, according to an embodiment.

FIGS. 4A and 4B are flowcharts of a method for online nutrition and shopping management according to an embodiment.

FIG. 5 is a flowchart of another method for online nutrition and shopping management according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

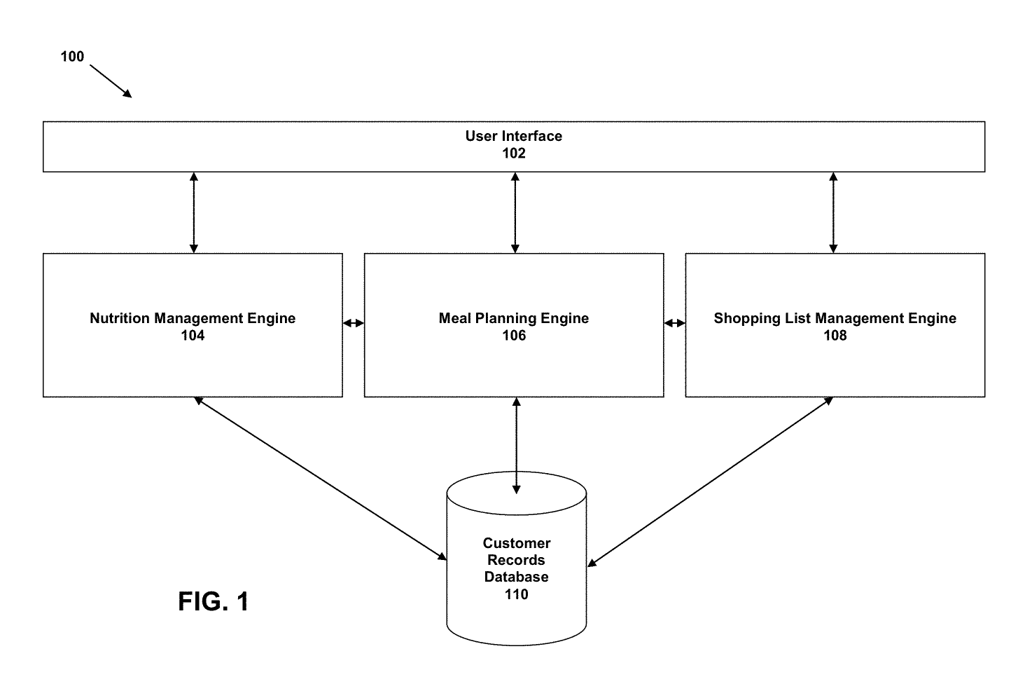

Referring to FIG. 1, a system 100 for nutrition and shopping management in an online networked environment is depicted, according to an embodiment. System 100 generally comprises a user interface 102, a nutrition management engine 104, a meal planning engine 106, a shopping list management engine 108, and a customer records database 110.

Embodiments of system 100 can be performed in cloud computing, client-server, or other networked environment, or any combination thereof. The components of system 100 can be located in a singular “cloud” or network, or spread among many clouds or networks. End-user knowledge of the physical location and configuration of components of system 100 is not required.

As will be described, system 100 and/or its components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor not only to provide space to execute the instructions or algorithms, but also to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

User interface 102 comprises a point of interaction that is adapted to relay information to a user from any of nutrition management engine 104, meal planning engine 106, or shopping list management engine 108 and receive information from a user for forwarding to any of nutrition management engine 104, meal planning engine 106, or shopping list management engine 108. The terms “user” and “customer” are used herein interchangeably for ease of explanation depending on the particular feature being discussed.

As shown in FIG. 1, user interface 102 is communicatively coupled with nutrition management engine 104, meal planning engine 106, and shopping list management engine 108. In an embodiment, user interface 102 comprises an interactive graphical user interface (GUI). In an embodiment, user interface 102 comprises a web-based user interface of a series of web pages. In an embodiment, user interface 102 comprises a traditional desktop computing software GUI. In other embodiments, user interface 102 can comprise command-line, touchscreen, voice, command-line, or any other desktop computing, mobile device, or cloud-based computing interface. In an embodiment, separate user interfaces 102 to nutrition management engine 104, meal planning engine 106, and shopping list management engine 108 are provided. In other embodiments, a single uniform user interface 102 provides an interface to nutrition management engine 104, meal planning engine 106, and shopping list management engine 108.

Nutrition management engine 104 is configured to receive and store customer-specific nutritional requirements. For example, customer-specific nutritional requirements can include a dietary requirement, a disease-specific diet, a food allergen, a food sensitivity, a food to be avoided, a preferred ingredient, or a dietary goal. Nutrition management engine 104 can receive customer-specific nutritional requirements via user interface 102. In an embodiment, customer-specific nutritional requirements can be selected from a list provided to the customer, entered free-form as text and translated by nutrition management engine 104, or any other suitable interface interaction.

As will be described with respect to customer records database 110, customer-specific nutritional requirements can be stored by nutrition management engine 104 in a customer record in customer records database 110. As such, nutrition management engine 104 is communicatively coupled to customer records database 110.

Meal planning engine 106 is configured to receive recipes and meal plans from a customer. Meal planning engine 106 can receive recipes and meal plans from a customer via user interface 102. In embodiments, meal planning engine 106 can utilize user interface 102 to allow the customer to edit the recommended plan and accept or reject the recommended plan while shopping real-time.

A recipe or meal plan received from a customer can include a home recipe or personal recipe of the customer. “Home recipes” can include non-traditional or specialized recipes not generally available through public sources; for example, “Grandma's Secret Meatloaf.” Customers who provide home recipes, in particular recipes that they wish to remain personal and private, can identify the recipe as “secret” such that it will not be shared with any other customers, but the customer can still utilize it in conjunction with the online shopping nutrition and shopping management tools provided by embodiments described herein. In embodiments, meal planning engine 106 is further configured to receive recipes and meal plans from one or more publicly available sources. For example, the publicly available source can be the Internet. In further embodiments, meal planning engine 106 is configured to suggest recipes (other than “secret” recipes”) and meal plans from an internal database to a customer based on the customer-specific nutritional requirements.

Meal planning engine 106 is further configured to store recipes and meal plans received from a customer, or selected by a customer in response to a suggestion, in the customer record of that customer, as will be described further with respect to customer records database 110. As shown in FIG. 1, meal planning engine 106 is communicatively coupled to customer records database 110.

In an embodiment, meal planning engine 106 is further configured to identify customer records having common customer-specific nutritional requirements and to cross-suggest, or “crowdsource,” products, recipes and/or meal plans to a user or customer associated with an identified customer record. For example, a customer identifying as lactose-intolerant can be provided with recipes and meal plans that have been used by other customers also identifying as lactose-intolerant. In some embodiments, meal planning engine 106 can obtain ratings or feedback about particular products, recipes, meal plans, etc., and use this additional data to make recommendations to customers with similar characteristics, purchase patterns, demographics or other data. Thus, meal planning engine 106 can comprise an algorithm (or system 100 can comprise a suggestion algorithm engine that comprises an algorithm) that includes one or more of scoring customers based on identified conditions, goals, characteristics or other data as discussed herein; predetermining and identifying suitable items associated with one or more conditions, goals, characteristics or other data, including substitute or replacement items for commonly used or problem items associated with some conditions (e.g., artificial sweeteners in place of sugar for diabetics); considering reviews and feedback from customers in weighting suitable, substitute and/or replacement items; and modeling, segmenting and matching customer data in order to provide suggestions and recommendations to customers based on one or more of the scoring, predetermining/identifying, considering, and modeling/segmenting/matching. In some embodiments, the algorithm can be used or adapted for recipes, meal plans, supplements, and other items that may be purchased by customers.

Shopping list management engine 108 is configured to provide a suggested shopping list that includes items required by the recipes and meals plans. For example, shopping list management engine 108 can provide a suggested shopping list via user interface 102. In embodiments, shopping list management engine 108 can receive recipes and meal plans provided or selected by a customer from meal planning engine 106 or directly from user interface 102.

In embodiments, shopping list management engine 108 can further provide a suggested shopping list that includes items required by the recipes and meals plans. In other embodiments, the items can be cross-checked against items available from the retailer. Shopping list management engine 108 can be further configured to store a history of purchased items by a customer in the customer record. In other embodiments, shopping list management engine 108 can review the customer record for previous purchase information if an item in the suggested shopping list is identified in the history as a previously purchased item. In embodiments, the previous purchase information can include a previous date of purchase. The date of purchase can then be utilized in tailoring or managing the shopping list. If the date of purchase of a previously purchased item is less recent than an expected use or expiration of the previously purchased item, the shopping list can be updated to include or prompt for that item. For example, if a recipe requires honey and the last purchase date of honey was six months ago, the shopping list can auto-populate the required amount of honey, or prompt the customer by inquiring, “Do you need honey?”

In embodiments, shopping list management engine 108 can be integrated with other shopping list functionality. For example, a customer can use a digital notepad or other note-taking or list-making software to make notes for shopping list items. The digital notepad list can be imported into shopping list management engine 108 for use in system 100. In another embodiment, a customer can use a physical pad of paper to make notes for shopping list items. An image can be taken by the customer's computing device to import shopping list data for use in system 100.

In one embodiment, a suggested shopping list comprises an online shopping cart auto-filled with items required by the recipes and meals plans and available for immediate purchase from the retailer. Embodiments can therefore be cross checked against multiple databases, such as recipe data, meal plan data, and retailer data. In another embodiment, shopping list management engine 108 provides a customer selection of either in-store pick-up or home delivery of the items in the online shopping cart.

In one embodiment, meal planning engine 106 is further configured to identify at least one ingredient to be avoided based on the customer-specific nutritional requirements or customer preferences provided via nutrition management engine 104. In such embodiments, shopping list management engine 108 is configured to review the items required by the recipes and meals plans and available from the retailer for the ingredient to be avoided and omit from the suggested shopping list items that include the ingredient to be avoided. For example, if a customer is sensitive to sugar or provides nutritional requirements to avoid sugar (e.g., identifies as diabetic), and a recipe or meal plan calls for sugar, shopping list management engine 108 could flag sugar as an ingredient and proactively suggest an alternative or list of options. In further embodiments, system 100 can identify and include on the suggested shopping list a substitute item suitable for use in the recipe and meal plan that does not include the ingredient to be avoided. Continuing the above “sugar” example, shopping list management engine 108 could remove or replace sugar with a suggested or recommended non-sugar alternative, such as an artificial sweetener or agave syrup, in some embodiments.

Customer records database 110 comprises a database configured to store customer records and data associated with customer records. In an embodiment, each customer record is associated with one of a plurality of customers for the retailer. Customer records database 110 can be a general purpose database management storage system (DBMS) or relational DBMS as implemented by, for example, Oracle, IBM DB2, Microsoft SQL Server, PostgreSQL, MySQL, SQLite, Linux, or Unix solutions, in embodiments.

As depicted in FIG. 1, customer records database 110 is communicatively coupled to nutrition management engine 104, meal planning engine 106, and shopping list management engine 108 such that data can be sent to customer records database 110 for storage. Further, each of nutrition management engine 104, meal planning engine 106, and shopping list management engine 108 can access customer records database 110 to retrieve data from customer records database 110.

In embodiments, customer record data can be aggregated or utilized across multiple customers. For example, meal planning engine 106 can be configured to identify, in the suggested shopping list, at least one item to be substituted based on purchased items in a customer record that has common customer-specific nutritional requirements with the customer to whom the suggested shopping list is provided. Because customers with similar nutritional requirements might make similar substitutions, the shopping list can be tailored based on existing customer records data. For example, meal planning engine 106 can read, from customer records database 110, data on a first customer who noted a gluten-free diet and made a substitution of rice flour for wheat flour in a recipe calling for wheat flour and reported a favorable result. Meal planning engine 106 can then access the record of a second customer who noted a similar gluten-free diet in order to suggest (i.e., populate via shopping list management engine 108 as needed) rice flour as a substitute for wheat flour. As customer records data grows, system 100 can make increasingly complex substitutions or recommendations. Increasingly specialized recommendations can likewise be made based on the crowdsourcing of customer records data as described herein.

In embodiments, system 100, using the data in customer records database 110, can provide customer feedback to increase customer awareness, add value to the customer's experience, and provide additional feedback and information to the customer. In one embodiment, system 100 can provide a weekly, monthly, quarterly, annual, or other periodic summary of purchases, caloric value thereof, and a relation to a stated goal, if one exists. For example, a customer indicating a desire to lose weight could receive a monthly summary report of items purchased, recipes used or meal plans followed; a summary of caloric load of those items, recipes or meal plans; a breakdown of nutritional information (e.g., protein vs. carbohydrates vs. fats); and a comparison to previous months (e.g., “This month you decreased purchases of high fat foods by 10%.”). The report can also include summaries of additional information, such as a list of items flagged that might have been harmful (e.g., “We identified 6 items this month that included nuts” when a customer has indicated a nut allergy or sensitivity). This report and the information in it can be customized for the customer, identified medical or nutritional needs or goals, purchase patterns, and other characteristics.

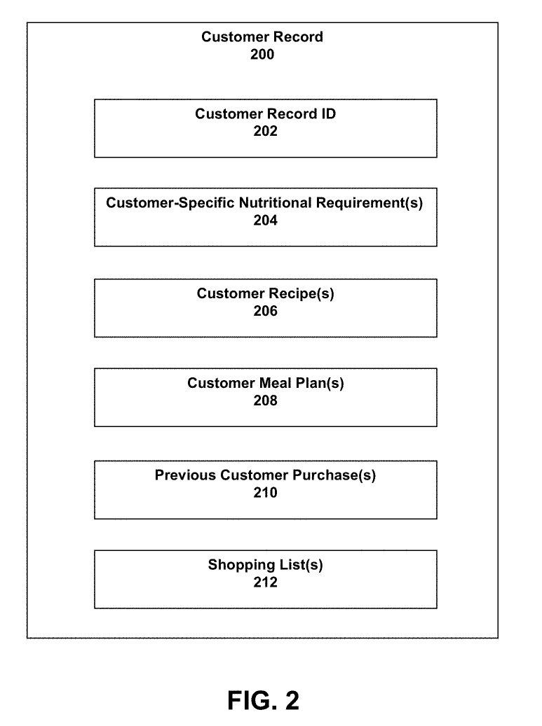

Referring to FIG. 2, a block diagram of a customer record 200 is depicted, according to an embodiment. Customer record 200 generally comprises a customer record ID 202, a customer-specific nutritional requirement 204, a customer recipe 206, a customer meal plan 208, a previous customer purchase 210, and a shopping list 212. Of course, one skilled in the art will readily appreciate that each of the data fields of customer record 200 can be stored in any suitable fashion, such as in a table. Further, each of the data fields of customer record 200 can include multiple components or instances. For example, a customer record 200 can store multiple customer recipes 206. Likewise, customer record 200 can include placeholders for any of the data such that a NULL value or no value is noted in customer record 200 where not applicable or not entered.

Customer record ID 202 can include an identifier for the particular customer record 200 for lookup in customer records database 110. In embodiments, customer-specific identifiers are hashed or otherwise replaced such that actual customer identifying data is not associated with any of the other data fields.

In an embodiment, each of customer-specific nutritional requirement 204 data, customer recipe 206 data, customer meal plan 208 data, previous customer purchase 210 data, and shopping list 212 data can be received from or accessed by nutrition management engine 104, meal planning engine 106, or shopping list management engine 108. In other embodiments, data can be segmented or otherwise given access restrictions such that read and/or write permissions are granted to certain engines.

Each of nutrition management engine 104, meal planning engine 106, and shopping list management engine 108 can be communicatively coupled with any of the other respective engines. In other words, data or arguments need not be passed through customer records database 110 only as depicted in FIG. 1. Rather, in certain embodiments, the engines can pass data between themselves, such as nutrition management engine 104 passing nutritional requirement data to shopping list management engine 108, and so on. In instances of nutrition management engine 104, meal planning engine 106, and shopping list management engine 108, a single sub-system such as a single web-based server can manage the operational variables for the system.

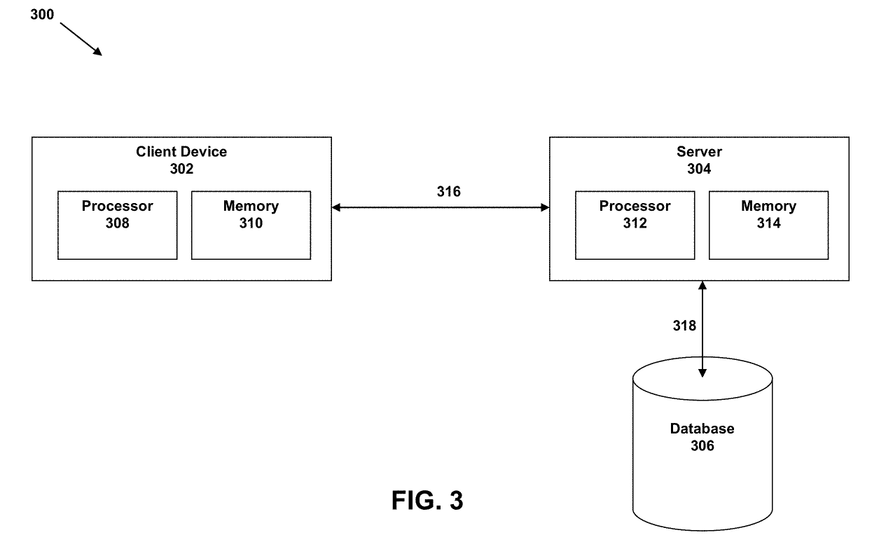

For example, referring to FIG. 3, block diagram of a nutrition and shopping management system 300 is depicted, according to an embodiment. System 300 generally comprises a client device 302, a server 304, and a database 306.

Client device 302 includes a processor 308 and a memory 310 operably coupled to processor 308. Client device 302 can be a desktop computer, laptop computer, or mobile device such as a tablet, smartphone, or smart watch. In an embodiment, the user interface 102 of system 100 is executed or displayed on client device 302. For example, processor 308 can execute device operating system commands utilizing memory 310 to present a device-specific user interface to the user of client device 302. In an embodiment, the device-specific user interface can include an Internet interface.

Server 304 includes a processor 312 and a memory 314 operably coupled to processor 312. In an embodiment, nutrition management engine 104, meal planning engine 106, and shopping list management engine 108 of system 100 are executed on server 304. For example, processor 312 can execute operational code utilizing memory 314 to instantiate one or more engines such as nutrition management engine 104, meal planning engine 106, and shopping list management engine 108. In other embodiments not depicted, engine execution is spread among multiple servers.

Database 306 comprises a database configured to data related to system 300. In an embodiment, database 306 comprises customer records database 110 of system 100. In other embodiments, database 306 comprises additional databases, such as online nutritional databases, customer-specific nutrition plan databases, or other nutrition, shopping list, or meal or nutrition-related databases. In other embodiments not depicted, data storage and retrieval of database 306 is spread among multiple databases.

As depicted in FIG. 3, client device 302 and server 304 are communicatively coupled by network connection 316. For example, network connection 316 can comprise an Internet, intranet, cloud-based, or similar network connection. Server 304 and database 306 are communicatively coupled by network connection 318. Similar to network connection 316, network connection 318 can comprise an Internet, intranet, cloud-based, or similar network connection. In embodiments, network connections 316 and 318 can comprise connections through the same network.

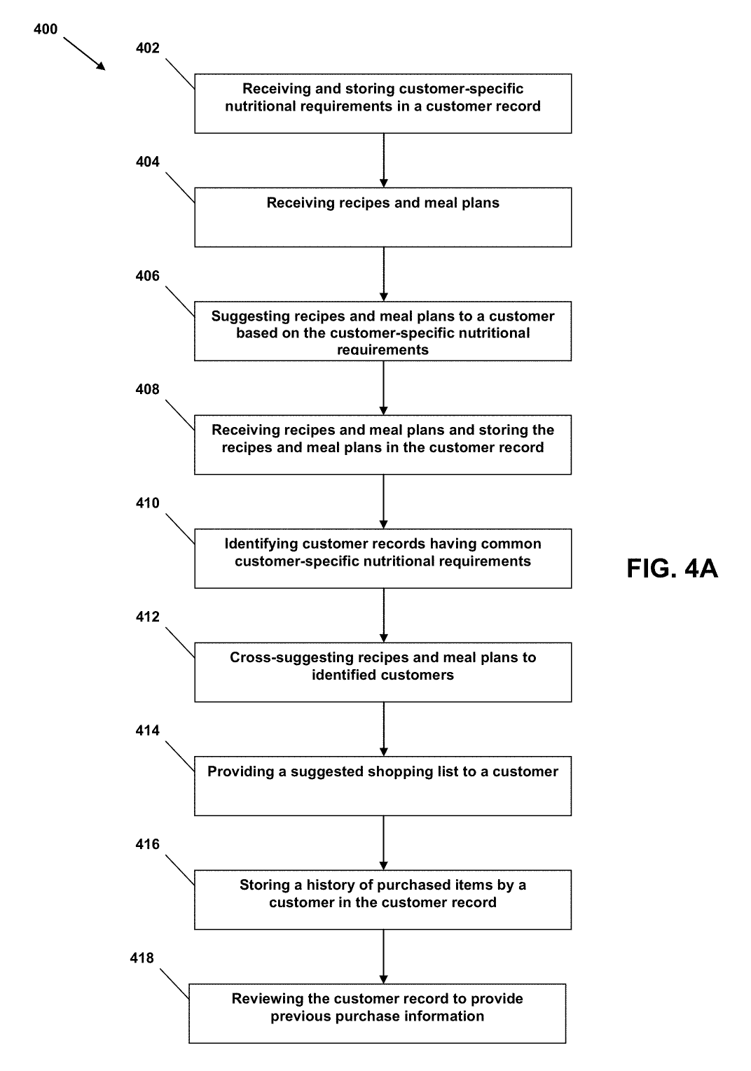

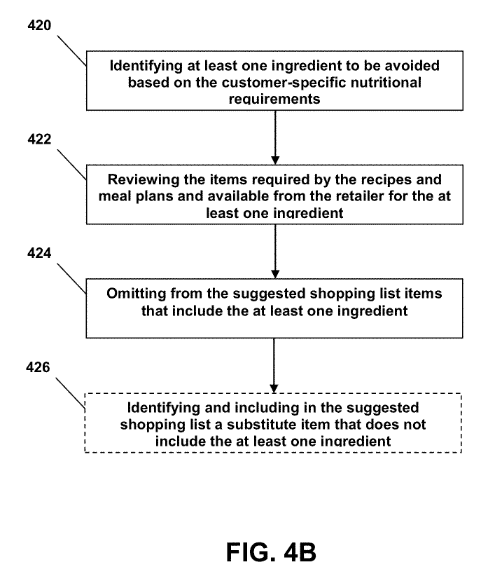

Referring to FIG. 4A, a flowchart of a method 400 for online nutrition and shopping management is depicted according to an embodiment. Method 400 can be implemented by, for example, the components of systems 100 and 300 as depicted in FIGS. 1-3.

At 402, customer-specific nutritional requirements are received and stored in a customer record. As described above with respect to system 100, customer-specific nutritional requirements can include a dietary requirement, a disease-specific diet, a food allergen, a food sensitivity, a food to be avoided, a preferred ingredient, or a dietary goal, for example. In an embodiment, each customer record is associated with only one of a plurality of customers.

At 404, recipes and meal plans are received. For ease of explanation, recipes and meal plans are described, but the recipes and meal plans can include a less formal aggregated food listing. In one embodiment, recipes and meal plans can be received from a customer, such as by a user interface. In further embodiments, recipes and meal plans received from the customers can include a “home recipe” of one of the plurality of customers. In further embodiments of method 400, a request can be received from a customer that the home recipe be a private recipe not permitted for cross-suggesting to customers associated with identified customer records. For example, the customer having the home recipe for “Grandma's Secret Meatloaf” can keep the recipe secret but still utilize the online shopping nutrition and shopping management tools provided by embodiments described herein.

In other embodiments, recipes and meal plans can be received from a publicly available source, such as on the Internet at a recipe website or meal plan website.

At 406, received recipes and meal plans are suggested to a customer based on the customer-specific nutritional requirements obtained at 402. For example, if the customer has specified a dairy sensitivity, a recipe for soy-based ice cream can be suggested to the customer.

At 408, recipes and meal plans are received from a customer. In an embodiment, the recipes and meal plans can be received from an ad-hoc transmission by the customer. In other embodiments, recipes and meal plans can be received in response to a suggestion from the system. The received recipes and meal plans are stored in the customer record of the customer from which they are received.

At 410, customer records having common customer-specific nutritional requirements are identified. For example, a first customer having an allergy to peanuts is identified as common to a second customer having an allergy to peanuts.

At 412, recipes and meal plans are cross-suggested to customers associated with the common customer-specific nutritional requirements. Continuing the example, if the first customer has a recipe for sunflower seed butter (as a substitute for peanut butter) stored in his customer record, the sunflower seed butter recipe can be suggested to the second customer.

At 414, a suggested shopping list is provided to a customer. In embodiments, the suggested shopping list includes items required by recipes and meal plans selected by the customer. In further embodiments, the suggested shopping list further includes items required by recipes and meal plans selected by the customer and available from the retailer.

At 416, a history of purchased items by a customer is stored in the customer record. For example, referring again to system 100, shopping list management 108 can interface to a point-of-sale system to identify actual purchased items. Alternatively, customer records database 110 can be accessed by a point-of-sale system to enter customer purchase data in the customer record.

At 418, the customer record is reviewed to provide previous purchase information if an item in the suggested shopping list is identified in the history as a previously purchased item. For example, if “bacon” is an item in the suggested shopping list and identified as a previously purchased item, the date of purchase of the previous purchase of the bacon can be used to modify or change the shopping list. If bacon was purchased just two days ago, for example, the customer might not need the bacon in the current shopping list. The method 400 can query the customer for additional information, in embodiments. The method 400 can alternatively automatically update the suggested shopping list based on the previous purchase data, such as by flagging bacon in the suggested shopping list and providing previous purchase information (e.g., “You purchased one pound of bacon earlier this week. Do you still want to purchase bacon now?”), or adjusting a bacon quantity in the suggested shopping list.

Referring to FIG. 4B, method 400 can further comprise, at 420 identifying at least one ingredient to be avoided based on the customer-specific nutritional requirements received and stored from 402.

At 422, items required by the recipes and meals plans and available from the retailer for the at least one ingredient are reviewed.

At 424, items in the suggested shopping list that include the ingredient to be avoided are flagged or highlighted in the suggested shopping list to identify them to the customer for further action (e.g., replacement or substitution, deletion, etc.). In some embodiments, items to be avoided can be removed from a shopping list and replaced with suggested alternatives, if they exist. Customer may opt-in for this auto-replacement feature in embodiments, such that omission can be automatic without input from the customer, or the replacement action can require customer confirmation or selection. In other embodiments, the customer is prompted before an item or ingredient is removed or omitted from the suggested shopping list.

Optionally, at 426, a substitute item that does not include the ingredient to be avoided can be identified and included on the suggested shopping list. In embodiments, the shopping list management engine 108 can therefore analyze the particular ingredients of items to determine their suitability for the particular customer.

Method 400 can further comprise identifying an item to be substituted in the suggested shopping list based on purchased items in a customer record having common customer-specific nutritional requirements with the customer to whom the suggested shopping list is provided.

Method 400 can further comprise auto-filling or pre-loading an online shopping cart with items in the suggested shopping list required by the recipes and meals plans and available for immediate purchase from the retailer. Therefore, items in the suggested shopping list can be cross-checked against items in stock at the retailer. In further embodiments, a customer selection can be provided for either in-store pick-up or home delivery of the items in the online shopping cart. In embodiments, customer preferences can be set prior to any determination of shopping cart items such that any shopping cart item additions automatically becomes an order preferred by the customer (such as a delivery order).

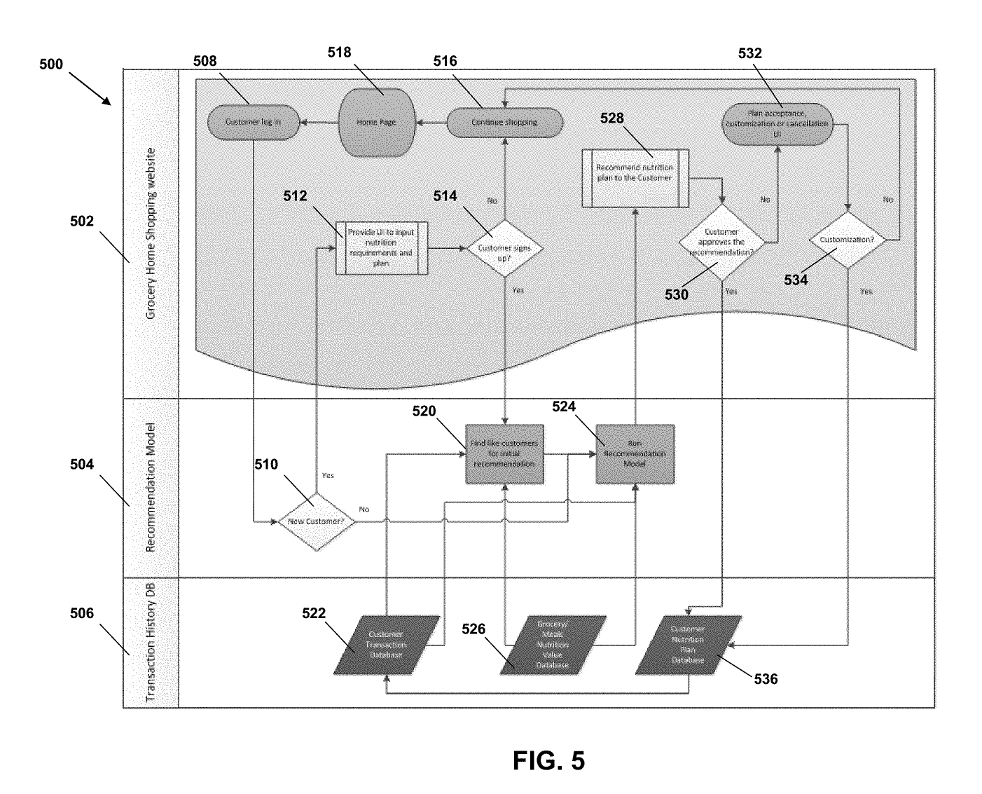

Referring to FIG. 5, a flowchart of a method 500 for online nutrition and shopping management is depicted according to an embodiment. As illustrated, method 500 can generally be implemented by system elements such as a shopping website 502, a recommendation model 504, and a transaction history database 506. As depicted in FIG. 5, portions of the system, such as shopping website 502, recommendation model 504, and transaction history database 506 can implement or execute the various method 500 steps. However, one skilled in the art will appreciate that method 500 tasks and activities can be spread across different or multiple system elements, depending on the particular embodiment.

At 508, a customer logs in to shopping website 502. For example, a customer can provide username and password in response to a login screen. In other embodiments, the customer device can be automatically validated and logged in via user security features, such as a fingerprint or voice identification.

At 510, recommendation model 504 determines if the customer is a new customer. If the customer is a new customer, a user interface is provided at 512 by shopping website 502 to receive customer nutrition requirements and nutrition plans. At 514, shopping website 502 queries the customer to sign up to a loyalty program or other customer data-storing feature of shopping website 502. If the customer declines to sign up, shopping website 502 allows the customer to continue shopping at 516. Method 500 then proceeds to shopping website 502 homepage. Returning to 510, if the customer is a not a new customer, method 500 proceeds to run a modeler by recommendation model 504, as will be discussed additionally below.

If the customer signs up based on the query at 514, customers similar to the instant customer are identified at 520 for an initial recommendation by recommendation model 504. Customer transaction database 522 can be accessed by recommendation model 504 as input to identify customers similar to the instant customer. Similarly, grocery/meals nutrition value database 526 can be accessed by recommendation model 504 as input for the initial recommendation calculations.

At 524, a modeler is run by recommendation model 504. Grocery/meals nutrition value database 526 can be accessed by recommendation model 504 as input for modeler 524. At 528, a recommended nutrition plan is presented to the customer by shopping website 502. A user interface can be utilized to present the entire plan or portions of the plan to the customer.

At 530, shopping website 502 queries the customer to approve the plan recommendation. If the plan is approved, the plan data is stored in customer nutrition plan database 536. As shown in FIG. 5, customer nutrition plan database 536 can included values input or overlapping with customer transaction database 522.

At 532, if the plan recommendation is not approved, shopping website 502 presents a plan acceptance, customization, or cancelation user interface.

At 534, shopping website 502 presents a customization interface to allow the customer to customize the recommendation plan. If the plan is chosen to not be customized by the customer, method 500 proceeds to continue shopping at 516. Shopping website 502 can thus present a suitable shopping interface. If the plan is chosen to be customized by the customer at 534, the customization data is stored in customer nutrition plan database 536.

Thus, embodiments allow for tailored online shopping according to customer needs and preferences. Systems and methods described herein allow for automated meal planning by considering dietary plans and recipes (including home recipes) to populate a shopping list. Further, shopping can be further automatically tailored for other dietary needs such as allergies, sensitivities, weight goals, and/or other medical issues prescribing a particular diet, and customer feedback loops can be implemented in order to share dietary plans, recipes, products, substitutions and other information with customers having similar dietary or medical needs, diagnoses and/or preferences. Embodiments can therefore recommend the grocery that the customer needs to shop in order to meet a customized nutrition plan.

Embodiments can provide additional features, such as learning from current and past purchases to provide suggestions or adjustments to modify recipes or shopping lists. Embodiments can therefore be run in real-time, with predictive diagnostics that run on top of historical data for the same customer or a similar customer. Embodiments also can provide feedback to customers, such as summary reports of purchases, to assist with tracking progress and further engagement.

In embodiments, automated reminders can be generated for items a customer may have forgotten or is likely to have forgotten. Similarly, a shopping list can be automatically populated with such items.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A nutrition and shopping management system comprising:
a nutrition management engine configured to receive and store customer-specific nutritional requirements in a customer record, each customer record associated with one of a plurality of customers;
a meal planning engine configured to receive recipes and meal plans from at least one customer and at least one publicly available source and to suggest recipes and meal plans to customers based on the customer-specific nutritional requirements, wherein the meal planning engine is configured to store recipes and meal plans received from a customer, or selected by a customer in response to a suggestion, in the customer record of that customer, and wherein the meal planning engine is configured to identify customer records having common customer-specific nutritional requirements and to cross-suggest recipes and meal plans to the customers associated with the identified customer records; and
a shopping list management engine configured to receive recipes and meal plans provided or selected by a customer and to provide a suggested shopping list comprising items required by the recipes and meals plans and available from the retailer, wherein the shopping list management engine is configured to store a history of purchased items by a customer in the customer record and to review the customer record to provide previous purchase information if an item in the suggested shopping list is identified in the history as a previously purchased item.

2. The system of claim 1, wherein the customer-specific nutritional requirements comprise at least one of a dietary requirement, a disease-specific diet, a food allergen, a food sensitivity, a food to be avoided, a preferred ingredient, or a dietary goal.

3. The system of claim 1, wherein the recipes and meal plans received from customers comprise at least one home recipe of one of the plurality of customers.

4. The system of claim 3, wherein the meal planning engine is configured to receive a request from the one of the plurality of customers that the at least one home recipe be a private recipe not permitted for cross-suggesting to customers associated with identified customer records.

5. The system of claim 1, wherein the meal planning engine is configured to identify at least one ingredient to be avoided based on the customer-specific nutritional requirements, and wherein the shopping list management engine is configured to review the items required by the recipes and meals plans and available from the retailer for the at least one ingredient and highlight in the suggested shopping list items that include the at least one ingredient.

6. The system of claim 5, wherein the shopping list management system is configured to identify and include on the suggested shopping list a substitute item suitable for use in the recipe and meal plan and that does not include the at least one ingredient.

7. The system of claim 1, wherein the meal planning engine is configured to identify in the suggested shopping list at least one item to be substituted based on purchased items in a customer record having common customer-specific nutritional requirements with the customer to whom the suggested shopping list is provided.

8. The system of claim 1, wherein the suggested shopping list comprises an online shopping cart auto-filled with items required by the recipes and meals plans and available for immediate purchase from the retailer.

9. The system of claim 8, wherein the shopping list management engine provides a customer selection of either in-store pick-up or home delivery of the items in the online shopping cart.

10. The system of claim 1, wherein the previous purchase information comprises a previous date of purchase.

11. The system of claim 1, wherein the at least one publicly available source comprises the internet.

12. The system of claim 1, wherein the meal planning engine is configured to solicit customer feedback related to recipes and meal plans and use the customer feedback to cross-suggest recipes and meal plans.

13. The system of claim 1, wherein the shopping list management engine is configured to provide the suggested shopping list for a first customer based on a shopping list of a second customer identified as having at least one of a similar customer-specific nutritional requirement or a similar shopping pattern.

14. The system of claim 1, wherein the shopping list management engine is configured to provide a summary report to a customer based on the history of purchased items in a period of time.

15. A nutrition and shopping management method comprising:
receiving and storing customer-specific nutritional requirements in a customer record, each customer record associated with one of a plurality of customers;
receiving recipes and meal plans from at least one customer and at least one publicly available source;
suggesting received recipes and meal plans to a customer based on the customer-specific nutritional requirements in the customer record;
storing recipes and meal plans received from a customer, or selected by a customer in response to a suggestion, in the customer record of that customer;
identifying customer records having common customer-specific nutritional requirements and cross-suggesting recipes and meal plans to the customers associated with the identified customer records; and
providing a suggested shopping list to a customer comprising items required by recipes and meals plans selected by the customer and available from the retailer;
storing a history of purchased items by a customer in the customer record; and
reviewing the customer record to provide previous purchase information if an item in the suggested shopping list is identified in the history as a previously purchased item.

16. The method of claim 15, wherein the customer-specific nutritional requirements comprise at least one of a dietary requirement, a disease-specific diet, a food allergen, a food sensitivity, a food to be avoided, a preferred ingredient, or a dietary goal.

17. The method of claim 15, wherein the recipes and meal plans received from customers comprise at least one home recipe of one of the plurality of customers.

18. The method of claim 17, further comprising receiving a request from the one of the plurality of customers that the at least one home recipe be a private recipe not permitted for cross-suggesting to customers associated with identified customer records.

19. The method of claim 15, further comprising:
identifying at least one ingredient to be avoided based on the customer-specific nutritional requirements;
reviewing the items required by the recipes and meals plans and available from the retailer for the at least one ingredient; and
flagging items that include the at least one ingredient in the suggested shopping list.

20. The method of claim 19, further comprising identifying and including on the suggested shopping list a substitute item suitable for use in the recipe and meal plan and that does not include the at least one ingredient.

21. The method of claim 19, further comprising omitting the flagged items from the suggested shopping list.

22. The method of claim 15, further comprising identifying in the suggested shopping list at least one item to be substituted based on purchased items in a customer record having common customer-specific nutritional requirements with the customer to whom the suggested shopping list is provided.

23. The method of claim 15, further comprising auto-filling an online shopping cart with items in the suggested shopping list required by the recipes and meals plans and available for immediate purchase from the retailer.

24. The method of claim 23, further comprising providing a customer selection of either in-store pick-up or home delivery of the items in the online shopping cart.
